(19) United States
(12) Patent Application Publication
(10) Pub. No.: US 2015/0302007 A1
(43) Pub. Date: Oct. 22, 2015

(54) System and Methods for Migrating Data

(71) Applicant: Lexmark International, Technology SA, Meyrin (CH)

(72) Inventor: Larry Robert Sitka, Stillwater, MN (US)

(21) Appl. No.: 14/555,068

(22) Filed: Nov. 26, 2014

Related U.S. Application Data
(60) Provisional application No. 61/909,020, filed on Nov. 26, 2013.

(51) Int. Cl. G06F 17/30

(52) U.S. Cl. CPC G06F 17/303; G06F 17/30598; G06F 17/30424; G06F 17/30312; G06F 17/30563

(57) ABSTRACT

A method of migrating data stored in a source device, the method comprising extracting one or more studies to be migrated from the source device; loading each of the one or more extracted studies into the storage device; receiving an identifier associated with each of the studies that have been loaded to the storage device. At the destination device, the one or more loaded studies are indexed using the identifiers. The method further includes transferring the storage device from a first location to a second location; and unifying the studies stored in the storage device with the indexed studies in the destination device.

### CROSS REFERENCES TO RELATED APPLICATIONS

Pursuant to 35 U.S.C. §119, this application claims the benefit of the earlier filing date of provisional application Ser. No. 61/909,020, filed Nov. 26, 2013, entitled “System and Methods for Migrating Data,” the contents of which is hereby incorporated by reference herein in their entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to data migration, and more particularly, to medical imaging data migration. The following description and drawings describe the background of the problem and representative solutions for overcoming it.

2. Description of the Related Art

When data is moved or consolidated from disconnected, intermittent, and limited environments that are geographically challenged and disparate to primary and secondary datacenter locations, traditional migration methodologies such as the physical migration of “lift-and-shift” may be used. The lift-and-shift migration methodology often involves taking a verified and successful backup of a system, powering it down, moving it to a destination and powering it back up. While this is a simpler way of moving data, the entire environment needs to be fully shut down and the outage of the environment starts from the initial shut down of the server, until the completion of operational verification testing at the new site.

While the lift-and-shift approach is beneficial for systems with low criticality and high tolerance for downtime, when moving hundreds of terabytes (TBs) of data such as, for example, medical imaging data, the migration and most especially the reproduction of the data at the HIVE, may take a long time (e.g. months), which would consequently cause a longer outage of the source system.

The alternative and more conventional data migration methodology of digitally transferring and consolidating data from the source environments to the primary and secondary datacenters, which may be located miles away from the source environments, can also take months, or even years, when hundreds of terabytes of data is moved.

These conventional methods of data migration may potentially cause high indirect cost such as longer downtime, lower productivity and loss of business. What is needed are faster and more efficient methods of moving huge amounts of data from to disconnected, intermittent, and limited environments that are geographically challenged and disparate to primary and secondary datacenters/HIVES/COOP locations.

### SUMMARY

Disclosed are a system and methods for migrating data from one or more source devices to a datacenter using a migration device. In one example embodiment, the method includes extracting one or more studies to be migrated from each of the one or more source devices. The one or more studies to be migrated may be queried using one or more attributes that the studies may match to determine if the studies are candidates for migration.

The studies extracted from each of the one or more source devices may be loaded to a storage device. In one example embodiment, the storage device may be a migration device, or may be communicatively connected with a migration device.

Once a study is loaded or stored in the storage device, an identifier of the location and other information regarding the loaded study may be generated. The identifier may be sent to a datacenter for indexing by the datacenter, even if the datacenter does not have a copy of the indexed study at the time of indexing. In one example embodiment, the identifier may be sent to the datacenter packaged in a metadata.

Once the migration device is loaded with the studies that need to be migrated, the migration device may be unplugged and disconnected from the source devices and physically transferred from a first geographical location to a second location. The second location may be a location that is within the vicinity of the datacenter. When the migration device arrives at the site of the datacenter, the studies stored in the migration device may be unified and assimilated with the datacenter using the previously indexed metadata in the datacenter. The studies stored in the migration device may be assimilated by an existing storage platform using the indexed metadata and are then unified with the existing storage subsystem. The information need not be copied or reprocessed using the datacenter.

From the foregoing disclosure and the following detailed description of various example embodiments, it will be apparent to those skilled in the art that the present disclosure provides a significant advance in the art of migrating data from one or more source devices or source environments to a datacenter. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example system for migrating content from one or more source environments to a primary and a secondary datacenter using a migration tool.

FIG. 2 shows an example migration workflow for migrating medical imaging data from geographically challenged locations to a datacenter.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the to referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable medium that may direct a computer or other programmable data processing apparatus to function in a particular manner, such that the instructions stored in the computer-readable medium may produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

A picture archiving and communication system (PACS) is a medical imaging technology that allows for storage and access to images from one or more modalities. Modalities may refer to any of various types of medical imaging equipment or probes that are used to acquire medical images of the body such as, for example, magnetic resonance imaging (MRI), ultrasound and radiography. Electronic images and reports generated by the modalities may be digitally transmitted between devices via PACS, thereby eliminating the need to manually process physical image jackets that may be alternatively generated by the to modalities. The universal format for storing and transferring images through PACS is Digital Imaging and Communications in Medicine (DICOM), while non-image content such as, documents, may be stored, transmitted in other industry standard formats such as the Portable Document Format (PDF).

DICOM is a standard or specification for transmitting, storing, printing and handling information in medical imaging. Medical imaging, as will be known in the art, may refer to a process and/or technique used to generate images of the human body, or parts or functions thereof, for medical and/or clinical purposes such as, for example, to diagnose, reveal or examine a disease. The standard set by DICOM may facilitate interoperability of various types of medical imaging equipment across a domain of health enterprises by specifying and/or defining data structures, workflow, data dictionary, compression and workflow, among other things, for use to generate, transmit and access the images and related information stored on the images. DICOM content may refer to medical images following the file format definition and network transmission protocol as defined by DICOM. DICOM content may include a range of biological imaging results and may include images generated through radiology and other radiological sciences, nuclear medicine, thermography, microscopy, microscopy and medical photography, among many others. DICOM content may be referred to hereinafter as images following the DICOM standard, and non-DICOM content for other forms and types of content, as will be known in the art.

Content may be generated and maintained within an institution such as, for example, an integrated delivery network, hospital, physician's office or clinic, to provide patients and health care providers, insurers or payers access to records of a patient across a number of facilities. Sharing of content may be performed using network-connected enterprise-wide information systems, and other similar information exchanges or networks, as will be known in the art.

For purposes of the present disclosure, it will be appreciated that the content may refer to files such as, for example, documents, image files, audio files, among others. Content may refer to paper-based records converted into digital files to be used by a computing device. Content may also refer to information that provides value for an end-user or content consumer in one or more specific contexts. Content may be shared via one or more media such as, for example, computing devices in a network.

In an example embodiment, content may refer to computerized medical records, to or electronic medical records (EMR), created in a health organization, or any organization that delivers patient care such as, for example, a physician's office, a hospital, or ambulatory environments. EMR may include orders for drug prescriptions, orders for tests, patient admission information, imaging test results, laboratory results, and clinical progress information, among others.

Content may also refer to an electronic health record (EHR) which may be a digital content capable of being distributed, accessed or managed across various health care settings. EHRs may include various types of information such as, for example, medical history, demographics, immunization status, radiology images, medical allergies, personal states (e.g. age, weight), vital signs and billing information, among others. EHR and EMR may also be referred to as electronic patient record (EPR). The terms EHR, EPR, EMR, document, content, object and informational objects may be used interchangeably for illustrative purposes throughout the present disclosure.

Metadata may refer to information regarding the content (e.g. DICOM and/or non-DICOM content). Metadata may provide information regarding the content such as, for example, information about a DICOM image data including dimensions, size, modality used to create the data, bit depth, and settings of the medical imaging equipment used to capture the DICOM image. Non-DICOM content may also contain metadata that provides information related to the content. Non-DICOM content metadata may include information such as, for example, a list of a patient's medical history, demographics, immunization status, radiology images, medical allergies, basic patient information, (e.g. age, weight), vital signs and billing information. In an alternative example embodiment, non-DICOM content may include non-DICOM medical image data objects such as, for example, diagnostic objects having standard consumer object formats such as, JPEG, PDF, MPEG, TIFF, WAV, but may not be structured data objects (e.g. DICOM objects). Non-DICOM content may also be objects having no standard information model and wherein its data format does not specify required and/or standard identifying information that is associated with the content.

Content metadata may also refer to “content about content,” or “information about content,” that allows users to identify the content. Examples of content metadata may include means of content creation, purposes of the content, time and date of content creation, creator of the content, author of the content, standards used in generating the content, origin of the content, information regarding history of the content (e.g. modification history), among many others. Content metadata may be used to search, access, modify or delete content stored in a database. Metadata may be stored and managed in a database such as, for example, a metadata registry.

Disclosed are a system and methods for migrating informational objects from one or more disconnected, intermittent, and limited environments that are geographically challenged and disparate to primary and secondary datacenters. In one example embodiment, the datacenters may be located at a significantly far location from the source environments. In the present disclosure, there may be a significantly huge amount of data to be migrated such as, for example, hundreds of terabytes of informational objects.

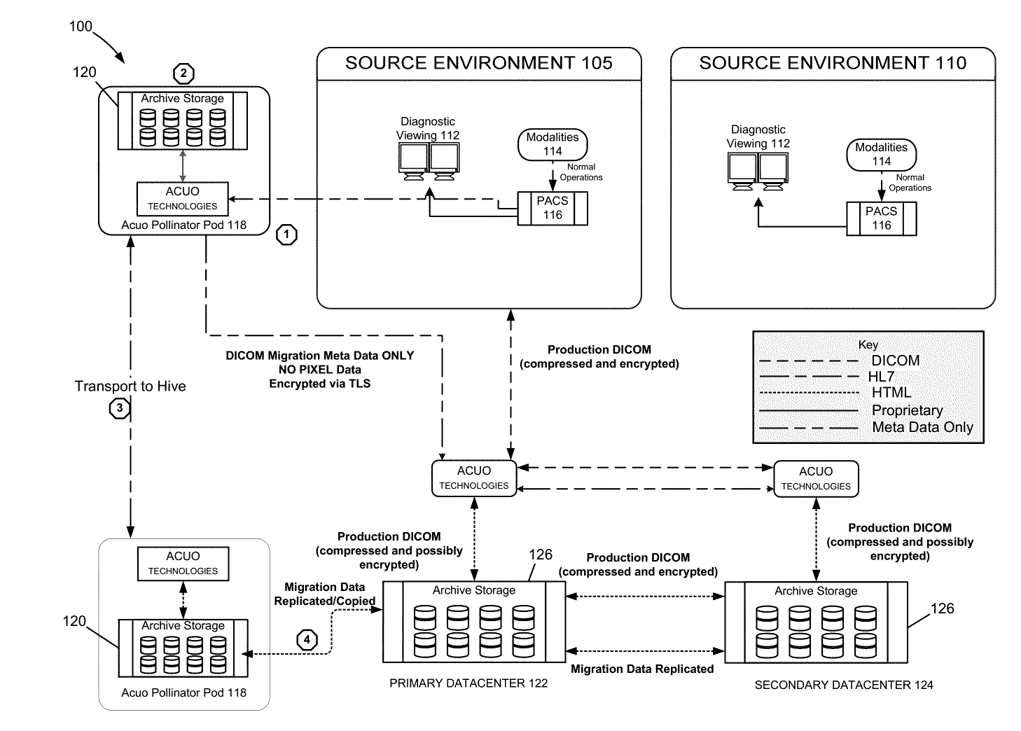

FIG. 1 shows an example system for migrating content from one or more source environments to a primary and a secondary datacenter using a migration tool. The first and second source environments 105 and 110 may each be a sub-system comprising diagnostic viewing devices 112, modalities 114, source PACS 116 and other devices that generate, manage and store content. Diagnostic viewing devices 112 may be computing devices that allow users to view medical content such as, for example, results generated by modalities. Examples of diagnostic viewing devices may include a desktop computer, or mobile devices such as, laptop computers, tablet computers, mobile phones, and the like. Other examples of diagnostic viewing devices will be understood by one of ordinary skill in the art.

Modalities 114 may be imaging equipment that obtains health or medical data regarding a patient. Modalities 114 are source machine types that generate patient data such as, for example, electronic images and may also be referred to herein as image modalities. Examples of modalities 114 may include plain radiography, angiography, mammography, ultrasound, magnetic resonance imaging (MRI), nuclear medicine, and the like. Modalities 114 may generate DICOM data having a DICOM modality attribute that represents the DICOM file type indicating the type of image modality that generated the data.

Source environments 105 and 110 may also include PACS 116. Picture archiving and communication system (PACS) 116 may be a DICOM archive that allows for convenient and economical storage, organization and access to medical images generated by one or more modalities or source machine types. Electronic images that are generated in one modality such as, for example, a mammogram, may be transmitted digitally via PACS 116. The storage and transfer of PACS images may follow the DICOM format.

In one example embodiment, source environments 105 and 110 may be to implemented using a medical informatics systems such as, for example, Composite Health Care System (CHCS) which implements the clinical gathering and documenting of data in modules and subsystems such as, for example RAD for radiology, PHR for pharmacy, PAD for patient administration, and the like.

The communication between diagnostic viewing devices 112 and PACS 116 may use proprietary protocols that are specific to the type of devices being used in the exchange while the modalities 114 and PACS 116 may communicate using DICOM standard and protocols. When communicating with the CHCS, HL7 may be used. HL7 is a framework providing standards for the exchange, sharing, integration and retrieval of electronic healthcare information.

For purposes of illustration, source environments 105 and 110 may be two of a plurality of disconnected, intermittent and limited environments that are geographically challenged and disparate such that migration of data from each of source environments 105 and 110 to primary and secondary datacenter locations may involve a lengthy period of time. Source environments 105 and 110.

Source environment 105 may be communicatively connected to Acuo Pollinator Pod (APP) 118 that may use an Assisted Migration software program to migrate data from PACS 116. For illustrative purposes, the informational objects (e.g. DICOM studies) to be migrated may be up to hundreds of terabytes of data. The Assisted Migration software program is configured with one or more computer instructions to extract, cleanse and move existing studies in a controlled manner from each of source environments 105 and 110 to pollinator. Pollinator is a service provided by Acuo by which migrations of hundreds of terabytes (TBs) of medical imaging data are moved from disconnected, intermittent, and limited environments such as source environments 105 and 110 that are geographically challenged and disparate to primary and secondary datacenters/HIVES/COOP locations. Pollinator meets the U.S. Army and U.S. Navy DIL requirements.

Once the informational objects, which may be hundreds of terabytes (TBs) in total size, are loaded into pollinator, a process which could take months, APP 118 is physically shipped to the destination or resting place. During the acquisition process, the notification and indexing messages are simultaneously sent to the COOP/HIVE/primary datacenter to facilitate indexing of the studies from the source environments 105 and 110 while the studies are still being prepared for shipping. At the destination, the stored studies to from APP 118 are assimilated by an existing storage platform and unifies with the existing clinical data management and storage subsystem. The content does not need to be copied or reprocessed through the system, saving many months in the process.

APP 118 may include one or more servers and associated storage having non-transitory computer readable storage media large enough to hold the content of the sources PACS 116 being migrated from source environments 105 and 110.

System 100 may also include a primary datacenter 122. Primary datacenter 122 may be a subsystem that stores data that goes beyond standard clinical data collected in a single provider's office and instead, store data from multiple content sources or content providers such as, for example, source environments 105 and 110.

System may also include a secondary datacenter 124. Secondary datacenter 124 may be a backup computing device that takes the place of the computing devices in the primary datacenter 122 if the primary datacenter 122 is unavailable for storing and/or retrieving data such as, for example, during a downtime condition of the primary datacenter 122. Each of the primary and secondary datacenters 122 and 124 may comprise one or more computing devices such as applications and databases. The computing devices are connected to each other in each datacenter subsystem by one or more communication links, as will be known in the art.

Each of the primary datacenter 122 and the secondary datacenter 124 may also include storage devices 126 for use in storing and archiving of studies and associated metadata migrated from source environments 105 and 110 to APP 118. In one example embodiment, the storage devices in primary and secondary datacenters 122 and 124 may be content-addressable storage (CAS) devices. CAS devices refer to devices that store information that are retrievable based on the content of the information, and not based on the information's storage location. CAS devices allow a relatively faster access to fixed content, or stored content that is not expected to be updated, by assigning the content a permanent location on the computer readable storage medium. CAS devices may make data access and retrieval up-front by storing the object such that the content cannot be modified or duplicated once it has been stored on the memory. In alternative example embodiments, the storage devices may be Grid, NAS, and other storage systems as will be known in the art.

In one example embodiment, the storage devices may be referred herein as archive devices that are used by primary datacenter 122 and secondary datacenter 124, respectively, in order to store or archive clip contents from APP 118. A clip may contain a set of related documents such as, for example, DICOM or non-DICOM documents.

Each of primary datacenter 122 and secondary datacenter 124 may include one or more databases for registering and/or storing metadata associated with content created by a content source in the source environments. At a certain point in time, the primary and secondary datacenters 122 and 124, may index and store metadata associated to content that is pending storage in primary and secondary datacenters 122 and 124.

Indexing of metadata in the primary and secondary datacenters may be performed using one or more databases in order for the content of interest, once shipped and copied from APP 118 to the datacenters, to be easily found, selected, and retrieved from at least one of the datacenters.

Metadata stored in the databases of the datacenters may be a collection of information received from APP 118 that allows an application such as, for example, a computer program, to quickly select desired metadata. The databases of the datacenters may organize metadata using fields and records such as, for example, in a SQL database. In an alternative example embodiment, accessing metadata stored in publisher and subscribers may be performed using a database management system (DBMS), or any other collection of programs that enables a user to enter, organize, and select stored data.

The storage devices, applications and databases in each of primary and secondary datacenters 122 and 124 may be communicatively connected to each other to manage content during one or more processes such as, for example, searching and retrieving of stored content using the metadata, and updating stored content using the metadata. Metadata stored in the databases and content stored in the storage device of primary datacenter 122 may be automatically replicated to the databases and storage devices of secondary datacenter 124, respectively.

In an alternative example embodiment, each of primary and secondary datacenters may also include a load balancer (not shown) for scheduling transactions on multiple computing devices in order to improve the over-all performance of the datacenters. The load balancer may be provided by a dedicated software and/or hardware.

The computing devices in system 100 may each include one or more processors communicatively coupled to a computer readable storage medium having computer executable program instructions which, when executed by the processor(s), cause the to processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to receive and send electronic medical images over a network. The processor(s) may include one or more general or special purpose microprocessors, or any one or more processors of any kind of digital computer. Alternatives include those wherein all or a portion of the processor(s) is implemented by an application-specific integrated circuit (ASIC) or another dedicated hardware component as is known in the art.

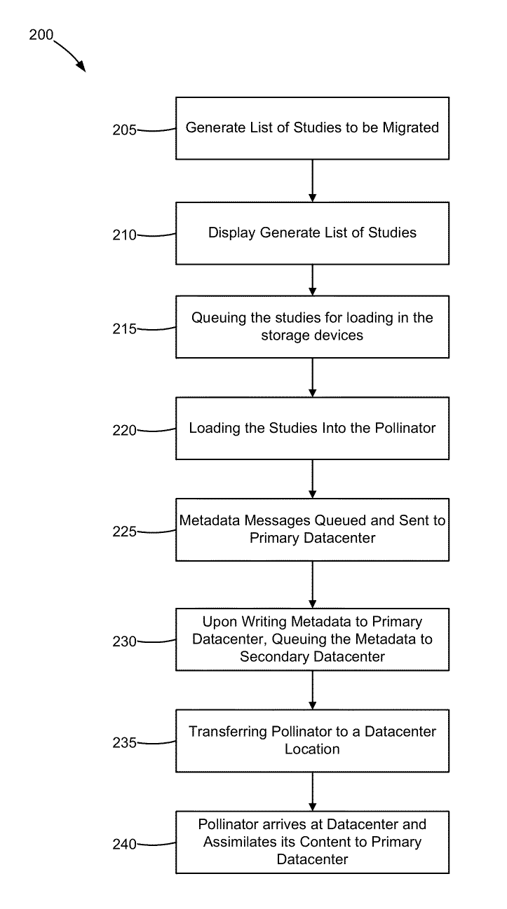

FIG. 2 shows an example migration workflow for migrating data from geographically challenged one or more source locations to a datacenter. For illustrative purposes, the data to be migrated may be medical imaging data. The migration may be performed in a plurality of phases. At phase 1, Acuo DICOM Assisted Migration (ADAM) may be loaded to APP 118 where it prepares the studies in the source environment for migration. At phase 2, the studies may be pulled from the source PACS in each of the source environments 105 and 110 whose studies are to be migrated. The pulled studies may be cleansed inside APP 118 and set to local storage, such as the storage devices 120 in APP 118, as indexed studies. The indexes of the stored studies may be sent to a datacenter for indexing. At phase 3, the APP 118 may be transported from the source environments to the appropriate COOP/HIVE/datacenter and at phase 4, the studies may be replicated from APP 118 to the appropriate datacenter using the indexes returned when the studies are stored in storage devices 120.

At 205, a list of one or more studies available for migration from the source PACS inside the example medical source environment 105 may be generated. The studies may be generated by running a controlled C-FIND request operation on PACS 116 to query studies from PACS 116. The C-FIND request operation may include a dataset containing two attributes that will be passed from a client application such as the DICOM Service Class User (SCU) to a server application such as the DICOM Service Class Provider (SCP). The C-FIND request or query may include one or more DICOM attributes to be matched by the existing studies.

A C-FIND request may be performed by establishing, by a client using a client to application SCU, the network operation to the PACS server or SCP. The client may prepare a C-FIND request message containing a list of DICOM attributes that may be filled in with data to be matched with the studies from PACS server. For example, to query for a study from a specify modality, the client may specify in the modality DICOM attribute the DICOM file type such as, for example, DSA for Digital Subtraction Angiography DICOM images, or NM for Nuclear Medicine DICOM images.

The client may also create empty attributes for all the DICOM attributes it wishes to receive from the SCP. For example, if the client wishes to receive an identifier that may use to receive images, the C-FIND request message must include an empty SOPInstanceUID (0008,0018) attribute.

After the preparation of the C-FIND request message, the message may be sent to the SCP. The SCP may respond back to the client a list of C-FIND response messages, each message containing a list of matching DICOM attributes, populated with the values requested for each match. The client then extracts the DICOM attributes that are of interest from the response message such as the studies that will be migrated from the source environment 105 to the datacenter.

The C-FIND request operation to query for studies to be migrated may be performed on an hour by hour, day by day, or year by year schedule. In an alternative example embodiment where the source environment 105 does not generate or store DICOM content and C-FIND request operation may not be applicable to query for studies or content from source environment, an SQL query may be used. Other retrieval operations that may be used will be known by skilled artisans.

At 210, the results of the C-FIND request operation may be listed or displayed. The list may be ordered as specified by a client using ADAM. For example, the list of studies returned may be listed according to the types of modalities and/or including the media the studies are coming from inside the source PACS. ADAM may be set to list studies according to one or more attributes. For example, ADAM may be set to skip tape or media segments if identifiers of media can be discovered from the list of studies.

At 215, the studies returned by the SCP may be queued for loading in storage devices 120 in an order as set in APP 118 and with cleansing rules applied. Cleansing rules are one or more settings that specify how the studies returned by the SCP are to be validated to and/or modified before they are loaded for migration. The cleansing rules may specify the fields to be validated, the actions to take if the data in the studies fails or passes validation, and one or more valid and invalid values to compare the studies against. The cleansing rules may also be used to define any values in the studies that will be replaced, deleted, and/or truncated by ADAM.

The queuing of the list of studies to migrate may be tied into the Health Level Seven International (HL7) order or MMWL events being generated inside the source environments. HL7 order may refer to the standards used in the exchange, sharing, integration and retrieval of electronic health information. The framework detailed in HL7 allows for an optimized workflow in the transfer of the studies from PACS 114 to the Pollinator.

At 220, the studies or informational objects, which may be hundreds of terabytes, are loaded into the pollinator. The studies may be stored in the local servers of APP 118 as an indexed list of studies. This process may take months depending on the size of the data being loaded.

At the same instance in time as the studies are pulled from the source PACS 116, cleansed inside APP 118, and set to local storage as an indexed study at blocks 205-125, DICOM metadata messages may be queued and sent to the primary datacenter (at block 225). The DICOM metadata messages may be notification and indexing messages that contains information that allows the primary datacenter to index the studies. The metadata may include identifiers of the studies that have been loaded into the pollinator and the identifiers may be used to index the studies in the primary datacenter even if the studies are not yet available in the primary datacenter.

At block 230, when the metadata message arrives and is written to the primary datacenter, the same message is then queued to be sent to a secondary datacenter for replication. Primary datacenter 122 may include one or more software applications that receive metadata replication tasks and performs one or more functions that allow primary datacenter 212 to send the metadata received from APP 118 over a network to at least one database of the secondary datacenter 124. The metadata received from APP 118 at this time is associated with content or a study that is not yet stored at primary datacenter 122.

Secondary datacenter 124 may include one or more software applications that receive and store the transmitted metadata in its own storage devices and databases. The to applications may configure secondary datacenter 124 to receive information from primary datacenter 122 such as, payload containing metadata associated with content pending migration in the primary datacenter 122, and indexing the metadata in the secondary datacenter by replicating the metadata in one or more databases in the secondary datacenter 124.

The study is now indexed not only at the primary datacenter 122 but also inside the primary datacenter's active failover, the secondary datacenter 124. The study may be indexed at the two datacenters but the copy of the study is not yet available at either datacenters and is pending full migration using APP 118.

At block 235, APP 118 may be unplugged and disconnected from the source environments and physically flown to the location of the datacenters. Once the pollinator is loaded with the studies that need to be migrated, APP 118 is shipped to the destination or resting place which may be in a different geographical location from those of the source environments.

At block 240, APP 118 arrives at the datacenter site and is configured to unify its contents with the primary datacenter. In one example embodiment, the storage device in APP 118 may have propagation and replication capabilities and then replicates itself from APP 118 to the storage devices in the primary datacenter 122.

When APP 118 arrives at the datacenter site, the stored studies are assimilated by an existing storage platform using the indexed metadata and are then unified with the existing storage subsystem. The information need not be copied or reprocessed through the primary datacenter site, saving many months in the process.

In another example embodiment, if the storage device in APP 118 does not have propagation and replication capabilities, the stored content may be copied and made available in the transferred APP 118 communicatively connected with the primary datacenter.

Services provided by APP 118 are designed to facilitate two primary functions. First, APP 118 provides a secure transport mechanism for migrating disparate PACS systems containing millions of studies but have limited WAN connectivity to one or more primary datacenters for the purposes of data consolidation under the Acuo UCP.

Second, APP 118 provides a means of moving vast quantities of terabytes of information in a more efficient manner by moving the content only once as a single to extraction from the source PACS contained in the source environment. The Dell DX Object Storage Platform also provides a means for unifying storage between APP 118 and the datacenters without requiring a physical second copy, removing the need for swing space, and reducing the need to make a secondary copy of the content which, when copying hundreds of terabytes of data, could take weeks or months to complete even from within the same datacenter or HIVES.

APP 118 uses a migration software program such as, for example, the standard Acuo DICOM Assisted Migrator (ADAM) migration process for extraction, cleansing, and movement of existing studies from the source environments in a controlled manner. Each Acuo Pollinator pod is designed to be a fully contained and functional VNA from servers to storage. Pollinator will then extract studies in the appropriate order specified inside the study migration list of APP 118. Pollinator then writes those studies into the Dell DX object based storage platform locally attached. Upon writing the series to the DX, a DX object ID is returned, indexed locally, and propagated to both datacenters/HIVE systems via a metadata replication process.

Once complete, APP 118 shall be shut down, disconnected from the source environments, and parked following a predefined set of steps and procedures designed specifically to secure the system. APP 118 is then shipped or flown logistically via a white glove service back to the primary datacenter or HIVE where it shall unify with existing Dell DX storage already in place.

Replicating the metadata of the studies extracted from the source PACS to APP 118 allows the object IDs to be replicated across both datacenters/HIVE/COOP sites without physically moving the payload of pixel data. The end result is the appearance of those studies existing and fully indexed in both datacenters thereby minimizing the interruption of business processes. The metadata replication process allows for seamless indexing of the studies stored on APP 118 inside the primary datacenter/HIVE/COOP and secondary datacenter/HIVE/COOP without the need for the study pixel data to physically reside inside the datacenters/HIVES/COOP. The metadata replication process may be based on clip content written on the storage device/s of APP 118. Replicating the metadata may include bundling the metadata using XML, in order to create an XML payload having the retrieved metadata. Creating an XML payload having the metadata may include annotating the metadata using standards and rules defined by XML markup language. The XML payload packages the retrieved metadata to structure, store and transport the metadata from source

PACS 116 to primary datacenter 122, or from primary datacenter 122 to secondary datacenter 124. In an alternative example embodiment, the XML payload may refer to data that is the cargo of a data transmission such as, for this example, the metadata that will be transmitted from source PACS 116 to primary datacenter 122, or from primary datacenter 122 to secondary datacenter 124.

The XML payload may be transmitted with information apart from the packaged metadata. This information may include a source database of the metadata to be replicated and will be added to the databases of the destination devices as a replication source when the information is transmitted to the destination devices. Information that is to be transmitted together with the packaged metadata may be referred herein as non-payload XML. Other data or information to be transmitted may include one or more target databases or databases to which metadata is to be replicated.

The Dell DX6000 Object Storage Platform's ability to unify itself with an existing DX storage cluster seamlessly also allows for a smoother migration process of content from the source PACS to the datacenters using APP 118. Following the pollinator process described above, it is a best practice to assign the IP addresses to the DX6000 Storage Nodes that will be used at the datacenter or HIVE locations.

After all of the data to be migrated has been acquired and written to the DX, the DX system will need a controlled shutdown procedure executed following the procedure documented in Chapter 2 of the DX Storage Administration Guide. Following the shipment to the datacenter/HIVE the DX6000 Storage Nodes can “join the cluster” at the central archive location(s). This procedure must be performed by someone specifically trained on this procedure and should have engineering support available. For example, the data will be considered stale by the DX cluster due to lack of health processor checks during shipping and there is a documented procedure to bypass this. This process will make the archive cluster aware of the data stored on the storage nodes. No image data is required to pass through any server or any network during this process. Since the Acuo UCP has all of the Meta-data and DX object IDs pre-indexed in both datacenters/HIVES/COOP sites, the studies will be available to the entire enterprise. The storage unification process usually takes at least a few days.

What is claimed is:

1. A method of migrating data stored in a source device, comprising:
extracting one or more studies to be migrated from the source device;
loading each of the one or more extracted studies into the storage device;
receiving an identifier associated with each of the loaded studies;
indexing, at a destination device, the one or more loaded studies using the associated identifier;
transferring the storage device from a first location to a second location; and
unifying the loaded studies stored in the storage device with the indexed studies in the destination device.

2. The method of claim 1, wherein the extracting the one or more studies includes sending a query to the source device specifying one or more attributes of the one or more studies to be extracted from the source device.

3. The method of claim 1, wherein the loading each of the one or more extracted studies includes queuing the one or more studies for loading in the storage device based on a migration order.

4. The method of claim 1, further comprising applying one or more cleansing rules to the one or more extracted studies prior to the loading of each of the extracted studies into the storage device.

5. The method of claim 1, wherein the extracting the one or more studies from the source device includes extracting the one or more studies from a source device among a plurality of source devices.

6. The method of claim 1, further comprising transmitting a metadata to the destination device, the metadata associated with the loaded studies.

7. The method of clam 6, wherein the indexing is performed after the metadata associated with the loaded studies has been received at the destination device.

8. The method of claim 1, wherein the metadata includes the identifiers of the loaded studies.

9. A system for migrating data, comprising:
a plurality of source devices that store one or more studies to be migrated;
a migration device communicatively coupled to the source device, the migration device including one or more instructions to:
extract the one or more studies from each of the plurality of source devices;
store each of the one or more studies in the migration device;
generate an identifier for each of the one or more stored studies; and
a datacenter communicatively connected with the migration device, the datacenter including one or more instructions to:
receive identifiers for each of the stored studies from the migration device; and
index each of the stored studies stored using the identifiers received from the migration device;
wherein, after the migration device has extracted and stored the studies to be migrated from each of the plurality of source devices, the migration device is physically transferred to a location in the vicinity of the datacenter; and the studies stored in the migration device and the indexes of the studies stored in the datacenter are unified upon successful transfer of the migration device.

10. The system of claim 9, wherein the migration device extracts the one or more studies from the source device by querying each of the plurality of source devices for studies that are candidates for migration.

11. The system of claim 10, wherein the candidates for migration are determined by querying studies stored in the plurality of source devices that match one or more specified attributes.

12. The system of claim 9, wherein the plurality of source devices are source devices that are geographically disconnected from each other.

13. The system of claim 9, wherein the one or more studies from the plurality of source devices are in a DICOM format.

14. The system of claim 9, further comprising a secondary datacenter that receives from the datacenter the identifiers associated with each of the one or more studies stored in the migration device.

15. The system of claim 14, wherein the secondary datacenter replicates content stored in the datacenter by indexing each of the one or more studies stored in the migration device using the identifiers received from the datacenter.

16. A non-transitory computer readable storage medium having one or more instructions to:
extract one or more studies from a plurality of source devices;
load each of the one or more extracted studies to a migration device;
receive an identifier associated with each of the loaded studies; and
send the identifiers to a datacenter for indexing by the datacenter; and
unify the loaded studies with the indexed studies in the datacenter.

17. The storage medium of claim 16, wherein the one or more instructions to extract the one or more studies includes one or more instructions to send a query to each of the plurality of source devices, the query including one or more attributes to be matched by the one or more studies to be extracted.

18. The storage medium of claim 16, wherein the migration device is transferred from a first location to a second location in the vicinity of the data center.

19. The storage medium of claim 18, wherein the one or more instructions to unify the studies between the migration device and the datacenter is performed when the migration device has been transferred from the first location to the second location in the vicinity of the datacenter.

20. The storage medium of claim 16, wherein the one or more instructions to send the identifier to the datacenter includes one or more instructions to package the identifier in a metadata and send the metadata to the datacenter.
